(19) United States
(12) Patent Application Publication
(10) Pub. No.: US 2008/0279533 A1
(43) Pub. Date: Nov. 13, 2008

(54) Process and apparatus for securing and retrieving digital data with a Portable Data Storage Device (PDSD) and Playback Device (PD)

(76) Inventor: David B. Buttars, Park City, UT (US)

Correspondence Address: DAVID B. BUTTARS, 8774 GORGOZA DR, PARK CITY, UT, 84098, US

(21) Appl. No.: 12/150,151

(22) Filed: Apr. 25, 2008

Related U.S. Application Data
(60) Provisional application No. 60/914,280, filed on Apr. 26, 2007.
(60) Provisional application No. 60/914,282, filed on Apr. 26, 2007.
(60) Provisional application No. 60/914,283, filed on Apr. 26, 2007.
(60) Provisional application No. 60/914,286, filed on Apr. 26, 2007.

(51) Int. Cl. H04N 5/91

(52) U.S. Cl. 386/94; 386/E05.004

(57) ABSTRACT

The invention is a process and apparatus for securing and retrieving digital data with a Portable Data Storage Device (PDSD) and Playback Device (PD). The PDSD-PD employs software and hardware security and encryption as barriers to those desiring illicit access to the stored data. Data is prepared with a Digital Rights Management (DRM) application which assigns a license object to the data and encrypts it using a Private Key managed Advanced Encryption Standard (AES) algorithm with 256-bit complexity. Private Keys are stored inside secured Field PGAs, PDSD, or PD. Another layer of AES encryption with 256-bit complexity is applied to the DRM license object using Public Key Infrastructure. Initial docking between a PDSD and PD initiates a sequence of routines and authentication. Interruption of the key exchange, authentication, or physical security measures may result in a lockout and/or the deletion of PDSD data. Potential applicable physical security measures are described.

### CROSS-REFERENCE TO RELATED U.S. PATENT DOCUMENTS

This is a Regular Nonprovisional Utility patent application under 35 U.S.C section 111(a). The entire disclosure of prior application Ser. No. 11/161,271 filed Jul. 28, 2005 and published Jan. 10, 2008, Publication no.: US 2008/008456 A1 is herein incorporated by reference.

Additionally, the entire disclosures of previously filed Provisional Utility Patent Application per 35 U.S.C. 111(b), Nos. 60/914,280, 60/914,282, 60/914,283 and 60/914,286 inclusive.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

As used in this description and in the appended claims, the word ‘Content’ means; all digital data, including but not limited to motion pictures, audio, musical works, video, video games, multi-media, interactive media, data files, programs and other works stored as digital data files

1. Field of the Endeavor to which the Invention Pertains

The invention relates to a method and apparatus for secure retrieval, storage and playback or use of video, audio, multimedia and other data on a variety of non-volatile storage media.

2. Background

In the current video distribution industry, Content is distributed in one of four basic methods: via theatrical release on either film-media or digital file, via optical disc on either DVD, HD-DVD, or Blu-Ray Disc, via Cable Television services or via internet service download or streaming. However, due to the realities of digital piracy, Content owners are reticent to enter the digital distribution arena with anything but low-value Content.

Optical discs are known to be highly insecure, despite industry attempts to protect DVDs against piracy with a copy-protection process called CSS, and Sony's attempt to protect Blu-Ray discs with an exclusive copy-protection process. In both cases, “ripper” software (software which circumvents the copy protection applied to a data file) is readily available. Since any security applied to an optical disc is static, once used on the disc it is available for infinite scrutiny and analysis by dedicated hackers until the protection scheme is deciphered.

State-of-the-art digital cinema distribution involves the content owner or distributor sending the cinema location an array of computer disk-drives which contain the movie ‘reels’ in digital form. These disks are encrypted with a private key application of AES 128-bit encryption, and the keys to ‘unlock’ this encryption are on a USB drive, sent in a separate mailing to the same cinema. Although fundamentally quite difficult to circumvent from the outside, recent piracy events in the digital cinema distribution process have involved internal personnel at the cinema level making a copy of the computer disk-drives (called “imaging” the drives), and then making a copy of the USB drive, thus completely circumventing the security of the AES 128-bit encryption.

Cable Television services have offered “on-demand” movie distribution, as well as a small amount of video game distribution for many years. Cable boxes provide some level of security, simply due to the proprietary nature of the boxes and the lack of readily available interfaces into these boxes. However, despite the relative security of these boxes, several illicit products are available to enable copying of content from Cable boxes from all manufacturers, and hence content owners tend to release to Cable at the same time as they release to DVD, with the understanding that piracy is inevitable once released.

Internet distribution has been fraught with several issues each of which discourages content owners from distributing high-value content through this channel. Internet delivery is first and foremost restricted due to overall capacity of the Internet infrastructure itself. The switching and routing capacity provided by the telecom providers is not capable of supporting wide-spread downloading of files the size of movies, particularly at higher definitions supported by DVD and Blu-Ray. For example, Blockbuster Video rents on average approximately 40 million movies every Friday night. If these were suddenly converted to Internet downloads over that same 6-hour period, the data-load on the switching and routing infrastructure would literally bring the Internet to a grinding halt. This issue is not considered a permanent problem, but it will take many years to increase the capacity of the entire Internet infrastructure to accommodate this volume. In addition to the infrastructure issues, Content security is a significant issue with Internet distribution models because the Content is generally downloaded to a Personal Computer (PC), and as a result, just like DVDs, the protection scheme is available for infinite scrutiny and analysis by dedicated hackers until the protection scheme is deciphered. Additionally, due to inherent frailties in the dominant Operating System (OS), protection schemes which rely on any of the OS resources become subject to those same frailties.

Encryption and protection methods that overcome the issues outlined above are currently available, and in some cases have been applied to a variety of data-protection applications, but all of these methods significantly reduce the data-availability and user-flexibility required to gain wide-range market acceptance. Users of data, particularly entertainment data, require access to the data on terms that fit their lifestyle, viewing habits, and variable schedules.

### BRIEF SUMMARY OF THE INVENTION

The invention comprises a method and apparatus for securing digital data in a highly available state within a Portable Data Storage Device (Storage Device), and subsequently making that data available for use through a corresponding Playback Device. One embodiment of the invention accomplishes this by utilizing a combination of physical, software, and hardware security and encryption methodologies to create multiple layers of onerous barriers to those desiring illicit access to the stored data, but through the novel security architecture used in the invention, the data is highly available to legitimate users. Although it is understood by the present industry that no security method is completely impossible to circumvent, the intention of this method and apparatus is to remove the potential reward from overcoming the method and apparatus due to the time and expense required to do so. In one embodiment, data is prepared with a Digital Rights Management (DRM) application which assigns a license object to the data, and then the data is encrypted using a Private Key managed Advanced Encryption Standard (AES) algorithm of up to 256-bit complexity. In this embodiment, the Private Keys are stored inside secured Field Programmable Gate Arrays (FPGA), or other secured hardware structure embedded in the Storage Device as well as the Playback Device and another layer of AES encryption of up to 256-bit complexity is applied to the DRM license object using Public Key Infrastructure (PKI). In this embodiment, initial docking between a Storage Device and a corresponding Playback Device, initiates a series of physical security routines (listed below) after which the stored public keys are exchanged, initiating the authentication of the license object, with control of the authentication process done by both the on-board processor of the Storage Device and the on-board processor of the Playback Device. In this embodiment, interruption of the key exchange, authentication, or physical security measures sensed by the processor of either device may result in the lockout of the device and/or the deletion of any data on the storage media. Applicable physical security measures include, but are not limited to impedance monitoring, random assignment of physical pins used for data transfer, data-masking with false data, chip-to-chip link encryption, use of Printed Circuit Board (PCB) masking layers, false traces, and X-Ray/Magnetic Resonance Imaging (MRI) resistant resin encasement of the PCB(s).

### BRIEF DESCRIPTION OF THE DRAWINGS

FIG. 1 is a graphic description of an embodiment of the invention showing the process of acquiring, securing, and preparing for distribution Content video files.

FIG. 2 is a graphic description of an embodiment of the invention where Content video files are distributed to end-users in combination with the distribution of a system of Storage Devices, Playback Devices, and Kiosks.

FIG. 3 is a graphic description of an embodiment of the invention where Content is secured during transfer between a Kiosk, Storage Device, and Playback device.

FIG. 4 is a graphic representation of the layering of the various security applications employed in an embodiment of the invention.

### DETAILED DESCRIPTION OF THE INVENTION

### Preferred Embodiment

The present invention comprises a method and apparatus for providing high levels of security to highly portable, highly available data, including but not limited to: video, audio, multimedia and other data, stored on any variety of non-volatile storage media. One embodiment of the invention relates to any number of processor-enabled flash-drive memory storage devices (Storage Device) combined with any number of processor-enabled playback devices (Playback Device), and processor-enabled distribution kiosks (Kiosks) used to distribute and play-back motion pictures and other audio/video data, programs or works. The present invention applies several layers of physical, software and hardware security methods to both the devices and to the data files.

The present invention provides a method and apparatus for applying superior security and copy-protection to video, audio, multimedia and other data stored on a variety of Storage Devices, and made available for viewing or use to a user via a playback device connected to any number of viewing devices such as: Televisions, Projection Screen Systems, Monitors, LCD Panels, Plasma Screens, or any other viewing system. The security and copy-protection of the invention secures the data in a highly-effective manner while simultaneously providing users access to the data with minimal obtrusiveness from the security. In one embodiment, video data is stored on a Storage Device. If an entity attempting to gain illicit access to the data stored on the Storage Device attaches leads to the interface pins of the Storage Device, the processor on-board the Storage Device immediately measures the impedance levels across the interface pins and compares it to the parameters pre-loaded to the Storage Device at the time of initial manufacture. In all circumstances, leads attached to these interface pins will create impedance levels significantly different to the impedance level measured when the Storage Device is docked in a Playback Device or to a Distribution Kiosk, and when these levels read outside of the expected parameters, the processor shuts down all data-transfer mechanisms, and reformats all sectors of the non-volatile memory media that contain valuable data.

In this embodiment, another layer of security is employed in the case where an entity attempting to gain illicit access to the data stored on the Storage Device successfully mimics the exact impedance levels required to pass the impedance measurement verification process. Once the impedance verification is complete, the processor on-board the Storage Device initiates a query which is sent to the Playback Device or Kiosk requesting a verification certificate. The verification certificates are loaded to all devices in the system at the time of manufacture. If the verification certificates are incorrect, or the chip addressing for the location of the certificates is incorrect, then the processor on-board the Storage Device shuts down all data-transfer mechanisms, and reformats all sectors of the non-volatile memory media that contain valuable data.

In this embodiment, if a user connects a legitimate Storage Device to a legitimate Playback Device or Kiosk, then the devices begin communication over a hardware encrypted interface. The user enters a secret PIN code through the Graphic User Interface (GUI) of either the Playback Device or Kiosk. After the PIN is entered, the Playback Device or Kiosk copy it's own digitally signed public key onto the Storage Device. This key is signed by the security module in the Playback Device or Kiosk, and also at the point of manufacture using a “chain of trust” approach, ensuring that entities attempting to gain illicit access to the data on the Storage Device cannot impersonate a genuine Playback Device or Kiosk.

In this embodiment, the Content is encoded and encrypted at the head-end using a strong symmetric key (using the AES system), and each Content file is given a random, unique key. When a Content file is sent to a Kiosk for distribution to Storage Devices, the Content file's key is digitally signed by the head-end and encrypted using the public key of the kiosk, so that only the kiosk can decrypt and use the key. When the kiosk receives the movie and key, it simply stores them in encrypted form on it's storage media.

In this embodiment, when a customer rents or purchases a Content file, the encrypted file key is loaded into the Kiosk's hardware security module. Additionally, when the customer docks the Storage Device into the Playback Device, the customer's Playback Device key is loaded into the security module on the Storage Device, and the Playback Device key is examined for authenticity (the digital signature and the chain of trust are verified) by the processor on-board the Storage Device. If the Playback Device is verified as legitimate, then the security module decrypts the Content file symmetric key using it's own private key; it then immediately encrypts it using the Playback Device's public key. Thus, the only time the Content file's key is in a decrypted state is inside the hardware security module. The Content file and the newly encrypted Content key are loaded onto the Storage Device, in addition to the License Object data (which itself is also encrypted and digitally signed by the Kiosk, with a chain of trust from the head-end).

In this embodiment, the Content file, encryption keys, and License Object are transferred to the Playback Device's security module. It decrypts the License Object using its private key, and verifies its authenticity and chain of trust. If the License Object indicates the user is allowed to view the Content file, the security module then decrypts the symmetric key using its private key. The Content file is streamed off the Storage Device in an encrypted state and into the Playback Device's security module. The security module decrypts the movie and outputs the decrypted file to the viewing device.

### DETAILED DESCRIPTION OF THE INVENTION

### Written Description Integrating the Drawings

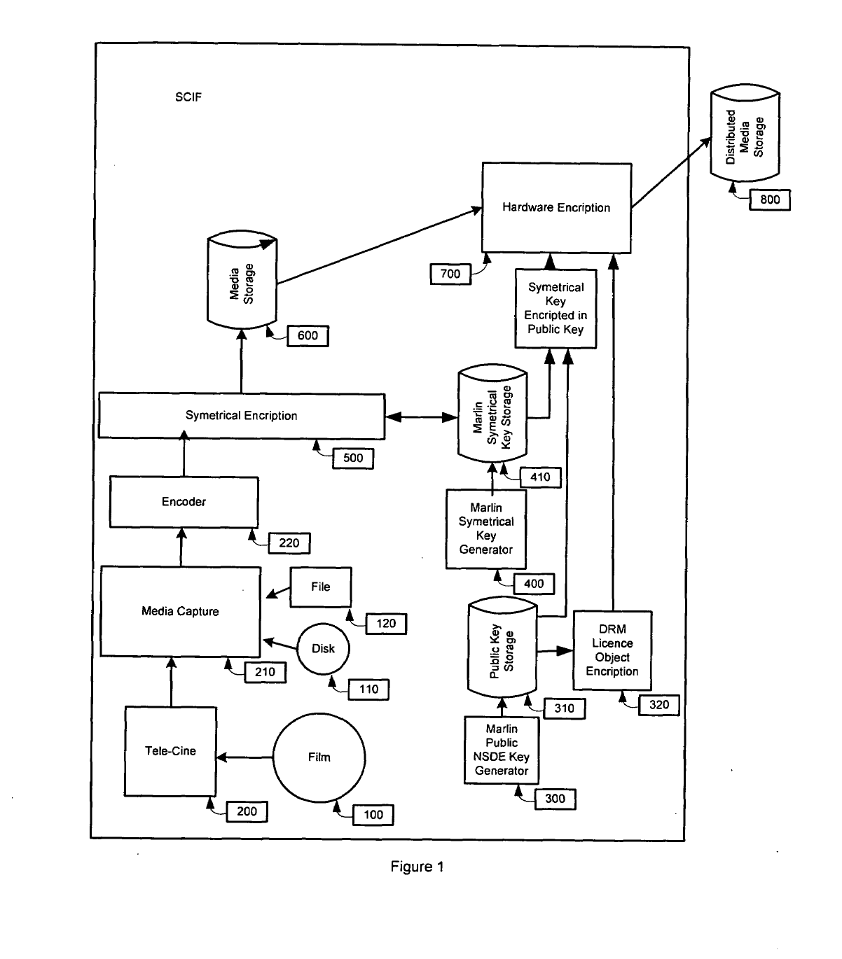

FIG. 1:

In an embodiment of the invention, an original, full-definition Content file is secured from the Content owner (Studio, Distributor, or other) and, in the case of film media (100), it is sent to a Tele-Cine service provider ((200) who converts the film media to digital format where it's then sent to a Media Capture facility (210) where it is loaded to an array of secured storage drives. In the case of digital media, the file (120) or disk (110) is sent directly to the Media Capture facility (210), where the Content is encoded using an Encoder (220). The encoded media is then encrypted using Symmetrical Encryption (500) and sent to the secured, permanent Media Storage facility (600). Using a Public NSDE Key Generator (300), PKI keys are generated and stored in a physically secured storage drive (310). License Objects are generated and encrypted using a DRM License Object Encryption process (320), and the PKI keys are pulled from the Public Key Storage drive (310). Symmetrical Encryption keys are generated using a Symmetrical Key Generator (400), and passed to a secured Symmetrical Key Storage drive (410). When the encoded Content passes from the Encoder (220) to the Symmetrical Encryption engine (500), the symmetrical encryption keys are passed from the Symmetrical Key Storage (410) and associated with the encrypted Content files prior to being passed to the Media Storage drives (600). Prior to distributing the Content to the distribution Kiosks, the Content receives a layer of Hardware Encryption (700) and also receives its associated encrypted License Object (320) after which it is passed to the remote Distributed Media Storage locations (800) in Kiosks or regional data centers.

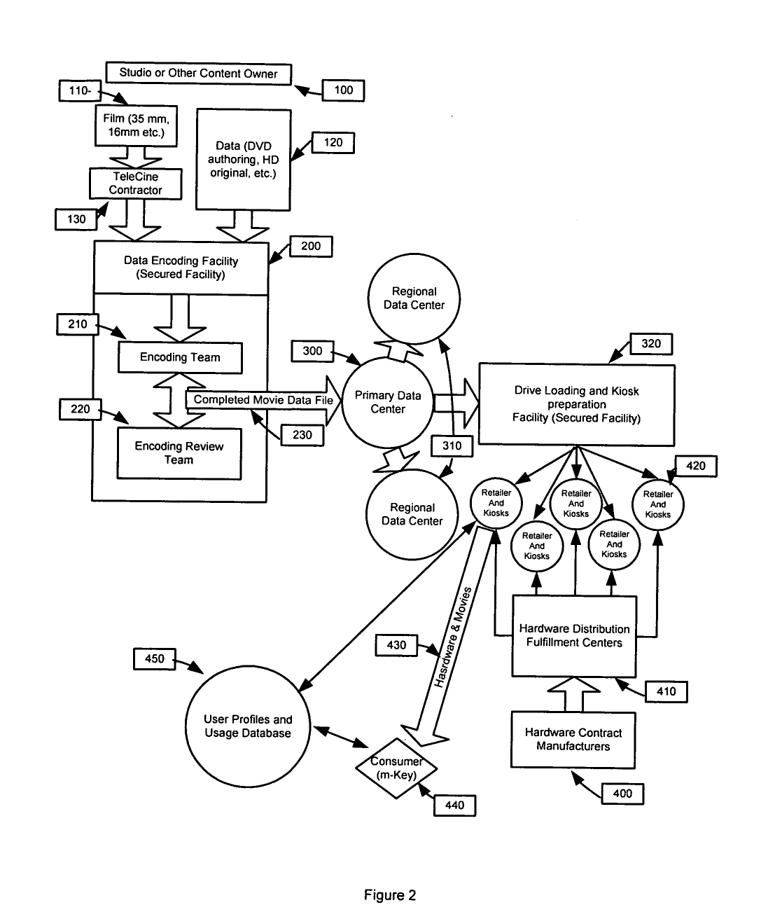

FIG. 2.

Content is received from a Studio or Content Owner (100) in either Film (110), or digital format (120). If received in film, it is converted to digital format through a Tele Cine service (130). Once the Content is in digital form, it is delivered to a secured Data Encoding Facility (200) where an Encoding Team (210) applies encoding to the Content, the encoding process is verified by an Encoding Review Team (220) and once certified, the Completed Data File (230) is delivered to the Primary Data Center (300), and subsequently Kiosk Drives (320) or to Regional Data Centers (310). Storage Devices and Playback Devices are manufactured at CEM facilities (400) and distributed through a variety of distribution relationships (410), to retail facilities (420), and from there to the Consumer (440) through a variety of retail channels (430). Data regarding customer use patterns, as well as any attempts at hacking the system are aggregated and tracked using Usage Databases (450), and that data is pushed back to the Kiosks (420) should a Storage Device show hacking patterns.

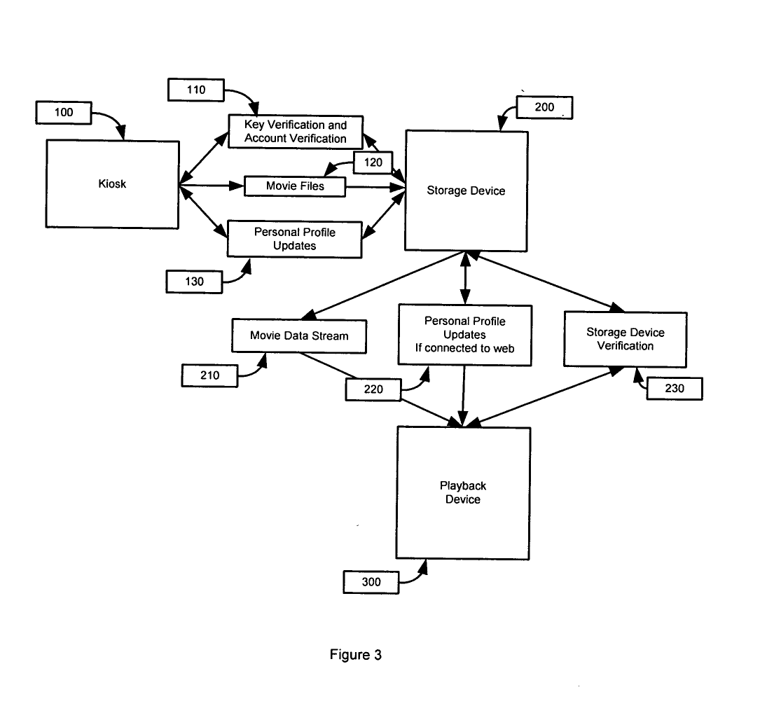

FIG. 3.

From the Content distribution Kiosk (100), Content files (120) are moved to Storage Devices (200) only after verification of the devices, encryption keys, and user accounts (110), and any updates to Personal Profiles (130) affecting security settings are affected. When the Storage Device (200) is docked into a Playback Device (300), the Storage Device is verified (230), and the Content Data is streamed (210) to the Playback Device (300). If the Playback Device (300) is connected to the web, then the Storage Device verification (230) will include a security update to confirm the validity of the Storage Device, as well as Personal Profile Updates (220).

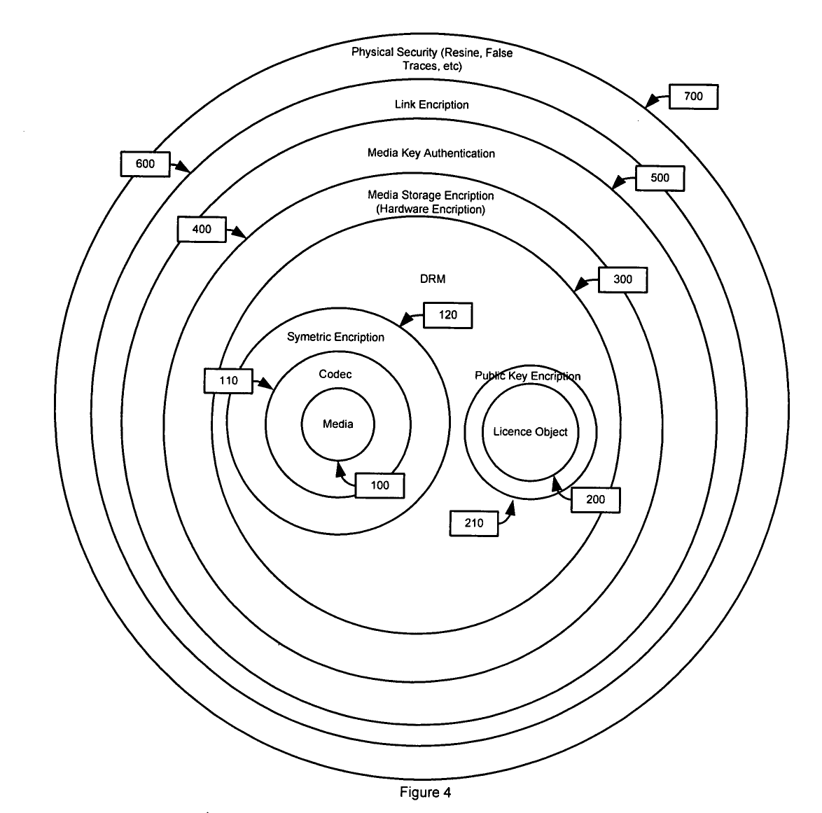

FIG. 4.

The functional Content File (100) is encoded with a Codec (110), and then subsequently encrypted with Symmetric Encryption (120). A License Object (200) is generated and encrypted with PKI Encryption (210), and then both the encrypted License Object (200) and the encrypted Content File (100) are wrapped in a DRM structure (300). The resultant package is encrypted with Hardware Encryption (400) for storage prior to delivery to distribution Kiosks. At the Kiosk, the Storage Device is Authenticated (500), and the communication between chips on the devices, as well as the communication between the devices themselves is Link Encrypted (600) ensuring the Content is never exposed in an unprotected state. External to all of the preceding methods, physical security layers are applied, including but not limited to impedance monitoring of the interface pins on the Storage Device, placement of false traces on all PCB's, and encasement of the PCB's in X-Ray/MRI resistant resin.

The preceding describes a method and apparatus for securing digital data in a highly available state within a Portable Data Storage Device (Storage Device), and subsequently making that data available for use through a corresponding Playback Device. Although the invention has been described with respect to certain example embodiments, it will be apparent to those skilled in the art that the present invention is not limited to these specific embodiments. Further, although the operation of certain embodiments has been described in detail using certain detailed process steps, some of the steps may be omitted, the steps may be performed in different sequences, or other similar steps may be substituted without departing from the scope of the invention. Other embodiments incorporating the inventive features of the invention will be apparent to those skilled in the art.

What is claimed is:

1. An apparatus for securing, retrieving, playing and encrypting digital data, the apparatus comprising:
(a) a processor-enabled, non-volatile media, data storage device with a secured FPGA or similar structure for storing encryption keys, and;
(b) a processor-enabled playback device with a secured FPGA or similar structure for storing encryption keys; and
(c) a processor-enabled distribution Kiosk with a secured FPGA or similar structure for storing encryption keys, which Kiosk stores encrypted Content files for distribution to Storage Devices upon demand, such that the integral combination of storage device, playback device and distribution kiosk acts as an apparatus for securing and retrieving digital data.

2. Method for securing, retrieving, playing and encrypting digital data, the method comprising:
(a) a processor-enabled, non-volatile media, data storage device with a secured FPGA or similar structure used as a mechanism for storing encryption keys; and
(b) a processor-enabled playback device with a secured FPGA or similar structure used as a mechanism for storing encryption keys; and
(c) a processor-enabled distribution Kiosk with a secured FPGA or similar structure used as a mechanism for storing encryption keys, which Kiosk stores encrypted Content files for distribution to Storage Devices upon demand, such that the integral combination of storage device, playback device and distribution kiosk acts as an apparatus for securing, retrieving, playing and scrambling digital data.

3. The invention of claim 1 or 2, or a combination thereof wherein the docking of the Storage Device into the Playback Device or Kiosk initiates a processor-driven verification of the impedance-levels across the interface pins and compares them against a pre-measured value, and; if the measured value is not within tolerances, the devices will not allow data to transfer between the devices, and the on-board processor of the Storage Device executes a ‘hard-delete’ of all content stored on the Storage Device.

4. The invention of claim 1 or 2 or a combination thereof wherein the result of the method of claim 3 is a successful comparison of impedance values, the Data Storage device and the Playback Device or Kiosk both initiate a transfer of a Randomly Generated Number (RGN) sequence from the Storage Device to the Playback Device or Kiosk, which sequence is then used to assign some number of interface pins as “data transfer” pins for that docking session.

5. The invention of claim 1 or 2 or a combination thereof wherein the completion of the method of claim 3 initiates transfer of data between the devices across the “data transfer” pins, and the simultaneous generation of false data which is transferred (transferring) across all pins not assigned as “data transfer” pins.

6. The invention of claim 1 or 2 or a combination thereof wherein the Kiosk is loaded with previously-encrypted Content, and corresponding encryption keys, and wherein the Kiosk processor encrypts the Content's encryption keys with it's own Public Encryption Key so that only the Kiosk can decrypt and use the key.

7. The invention of claim 1 or 2 or a combination thereof wherein at the demand of a Storage Device user, the Kiosk creates and encrypts a License Object defining the Content use parameters, integrally associating with the corresponding Content, and subsequently transferring the encrypted License Object to the Storage Device prior to initiating the transfer of the previously-encrypted Content to the Storage Device.

8. The invention of claim 1 or 2 or a combination thereof wherein the License Object is transferred from the Storage Device to the Playback Device and the License Object is decrypted using the encryption keys stored on the Playback Device.

9. The invention of claim 1 or 2 or a combination thereof wherein the Content is transferred to the Playback Device to the Playback Device and the Content is decrypted using the encryption keys stored on the Playback Device.

10. The invention of claim 1 or 2 or a combination thereof wherein the Storage Device monitors the expiry parameters of the License Object, and, upon expiry of the License Object, the on-board processor of the Storage Device executes a re-formatting of the section of the non-volatile memory holding the associated Content, resulting in a complete erasure of that associated Content.
